(19) United States
(12) Patent Application Publication
(10) Pub. No.: US 2012/0306444 A1
(43) Pub. Date: Dec. 6, 2012

(54) BREAKAWAY DEVICE FOR ELECTRIC VEHICLE SUPPLY EQUIPMENT

(75) Inventors: Linh Pham, Chula Vista, CA (US); Antonio Smith, Chula Vista, CA (US); Kenneth J. Brown, Chula Vista, CA (US); Sural Yegin, Chula Vista, CA (US)

(73) Assignee: LEVITON MANUFACTURING CO., INC., Melville, NY (US)

(21) Appl. No.: 13/153,389

(22) Filed: Jun. 3, 2011

(51) Int. Cl. H02J 7/00

(52) U.S. Cl. 320/109

(57) ABSTRACT

In one embodiment, an electric vehicle charging system includes a pilot conductor arranged to disconnect from an electric vehicle supply circuit before a power conductor when a cord disengages from an enclosure under excessive strain. In another embodiment, an electric vehicle charging system includes an enclosure having a breakaway portion. A strain relief engages the cord with the breakaway portion of the enclosure, and the breakaway portion is adapted to disengage from the enclosure when the cord is subjected to excessive strain.

### BACKGROUND

FIG. 1 illustrates a typical arrangement for charging an electric vehicle (EV) such as a plug-in electric vehicle (PEV), plug-in hybrid electric vehicle (PHEV), etc. Electric vehicle supply equipment (EVSE) 10 receives electric power from a utility grid or other source and transfers it to the vehicle 12 through a cord 14 and connector 16 that plugs into a mating inlet 18 on the vehicle. In this example, the AC power from the grid is converted to DC power by an on-board charger 20 in the vehicle to charge the battery 22.

The EVSE, which is also referred to as supply equipment, a vehicle charger, a charging station, a charger, etc., may be realized in several different mechanical configurations. EVSE are frequently installed as wall-mounted units in garages and on buildings where vehicles can be parked inside or close to the building. In outdoor locations, especially parking lots and curbsides, EVSE are commonly installed on pedestals. EVSE may also take the form of a cord set which is sometimes referred to as a travel charger, portable charger, handheld charger, etc.

The connector 16 and inlet 18 typically utilize a conductive connection in which the electrical conductors in one connector make physical contact with the electrical conductors in the other connector. Other systems utilize inductive coupling in which energy is transferred through magnetic coils that are electrically insulated from each other.

To promote interoperability of vehicles and supply equipment, the Society of Automotive Engineers (SAE) has developed various standards that define mechanical configurations of connectors for charging vehicles, as well as the arrangement and function of electrical contacts within the connectors. One standard known as SAE J1772 is of particular interest because virtually every automaker in the U.S., Japan and Europe has announced plans to use J1772 compatible connectors for models sold in the U.S. This standard relates to conductive charging systems and covers both AC and DC connections.

FIG. 2 illustrates a reference design for a conductive vehicle charging system under the J1772 standard. A vehicle 30 is coupled to EVSE 28 through a coupling inlet 26 on the vehicle and coupling connector 24, which is typically connected to the EVSE through a flexible cord. AC power is transferred to the vehicle through terminals 1 and 2 of the coupling. A charging circuit interrupting device (CCID) 44 interrupts the flow of AC power if the difference between the current flowing in the two AC conductors exceeds a predetermined threshold, which typically indicates a potential ground fault condition. An on-board charger 32 in the vehicle converts the AC power to DC current for charging the battery 34.

Terminal 5 of the coupling connects safety grounding conductors in the EVSE and the vehicle. A control pilot signal is connected through terminal 6 and enables basic two-way communications between the EVSE and the vehicle. For example, the control pilot enables a charge controller 36 in the vehicle to determine the maximum amount of AC current available from the EVSE, while it enables the EVSE to determine if the vehicle requires ventilation for charging and if the vehicle is ready to receive power. The return path for the control pilot signal is through the grounding path which enables it to serve a safety function: if the safety pilot signal is not present, control electronics 42 in the EVSE assumes the ground path has been compromised and causes the CCID to interrupt the flow of AC power to the vehicle. A proximity device 40 enables the vehicle to verify that it is mechanically connected to an EVSE system.

### SUMMARY

An electric vehicle charging system may include an enclosure, an electric vehicle supply circuit disposed within the enclosure, a cord to connect the electric vehicle supply circuit to an electric vehicle, wherein the cord includes a power conductor and a pilot conductor, and a strain relief to engage the cord with the enclosure, wherein the strain relief is adapted to disengage the cord from the enclosure when the cord is subjected to excessive strain, wherein the pilot conductor is arranged to disconnect from the electric vehicle supply circuit before the power conductor when the cord disengages from the enclosure.

The portion of the pilot conductor between the strain relief and the electric vehicle supply circuit may have substantially less slack than the portion of the power conductor between the strain relief and the electric vehicle supply circuit. The pilot conductor may include a disconnect device. The disconnect device may include a wire nut, a breakaway connector and/or a sliding contact connector. The strain relief may include a substantially cylindrical body arranged in a hole in the enclosure. The cylindrical body may be threaded and the strain relief may include a nut engaged with the threaded body.

An electric vehicle charging system may include an enclosure having a breakaway portion, an electric vehicle supply circuit disposed within the enclosure, a cord to connect the electric vehicle supply circuit to an electric vehicle, and a strain relief to engage the cord with the breakaway portion of the enclosure, wherein the breakaway portion of the enclosure is adapted to disengage from the enclosure when the cord is subjected to excessive strain.

The breakaway portion may include a punch-out. The punch-out may be secured to the enclosure with a coating, a nick, friction, etc. The breakaway portion may be substantially circular. The breakaway portion may include a plug, which may include a tapered stopper. The plug may include a lip to engage the enclosure.

An assembly may include an enclosure having a breakaway portion, and an electric vehicle supply circuit disposed within the enclosure, wherein the breakaway portion includes an opening for a cord to connect the electric vehicle supply circuit to an electric vehicle, and wherein the breakaway portion is adapted to disengage from the enclosure when the cord is subjected to excessive strain. The breakaway portion may include a punch-out and/or a plug.

### BRIEF DESCRIPTION OF THE DRAWINGS

FIG. 1 illustrates a typical arrangement for charging an electric vehicle.

FIG. 2 illustrates a reference design for a conductive vehicle charging system.

FIG. 3 illustrates an embodiment of a technique for de-energizing an EVSE charging cord according to some inventive principles of this patent disclosure.

FIG. 4 illustrates an embodiment of an EVSE system having a breakaway charging cord according to some inventive principles of this patent disclosure.

FIG. 5 illustrates another embodiment of an EVSE system having a breakaway charging cord according to some inventive principles of this patent disclosure.

FIG. 6 illustrates the embodiment of FIG. 5 when the strain relief has disengaged from the enclosure.

FIG. 7 illustrates a prior art technique for accommodating mechanical forces encountered when an EVSE cord is subjected to excessive strain.

FIG. 8 illustrates an embodiment of an EVSE system having an enclosure with a breakaway portion according to some inventive principles of this patent disclosure.

FIG. 9 is a perspective view of another embodiment of an EVSE system having an enclosure with a breakaway portion according to some inventive principles of this patent disclosure.

FIG. 10 is a cut-away view of the embodiment of FIG. 9.

FIGS. 11 and 12 illustrate an embodiment of a method for forming a breakaway portion of an enclosure according to some inventive principles of this patent disclosure.

FIG. 13 is a cutaway view illustrating another embodiment of an EVSE system having an enclosure with a breakaway portion according to some inventive principles of this patent disclosure.

FIG. 14 is a cutaway view of another embodiment of an EVSE system having an enclosure with a breakaway portion according to some inventive principles of this patent disclosure.

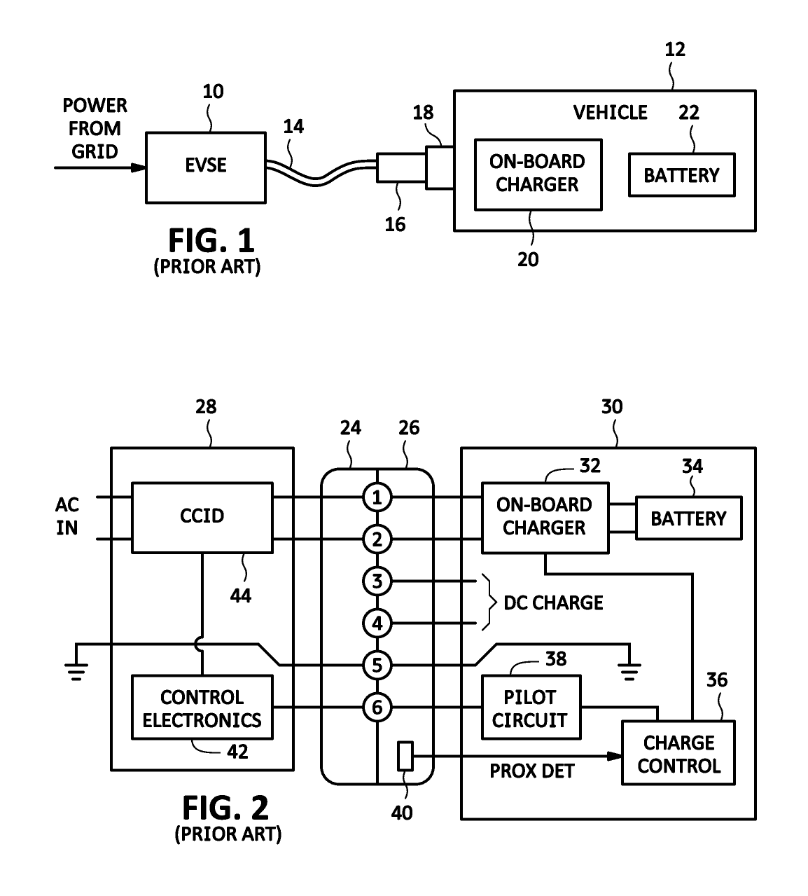

### DETAILED DESCRIPTION

For convenience, the term electric vehicle will be used to refer to pure electric vehicles (EVs), plug-in hybrid electric vehicles (PHEVs), and any other type of vehicle that utilizes electric charging.

Electric vehicle supply equipment (EVSE) typically includes an electric vehicle supply circuit. An electric vehicle supply circuit is designed to provide power to an electric vehicle from a power source and includes at least an interrupting device and control circuitry to cause the interrupting device to interrupt the flow of power from the power source to the electric vehicle in response to conditions relevant to electric vehicles. Examples of conditions relevant to electric vehicles include a ground fault condition, an inoperable grounding monitor circuit, the absence of a vehicle connected to the EVSE, absence of a ready signal from the vehicle, etc.

One potential problem with electric vehicles is that the operator may inadvertently drive away from the charging station while the vehicle is still connected to the charging station through the cord and charge coupler. To mitigate any hazards that may result from this type of situation, Section 625.19 of the National Electrical Code (NEC) provides that electric vehicle supply equipment or the cable-connector combination of the equipment shall be provided with an automatic means to de-energize the cable conductors and electric vehicle connector upon exposure to strain that could result in either cable rupture or separation of the cable from the electric connector and exposure of live parts. The NEC, however, provides no guidance on how such de-energization may be accomplished.

A prior art technique for de-energizing the cable conductors involves the use of a tether to open a switch when the charging cord is stretched beyond a certain length. The tether is made of light gauge wire rope and has one end attached to a point on the charging cord. The other end of the tether is attached to a magnet that is normally placed on the front panel of the EVSE enclosure to hold a set of electrical contacts in the closed position. If the charging cord, which may be a coiled cable, is stretched beyond a certain length, the tether pulls the magnet away from the front panel of the EVSE, thereby opening the electrical contacts and causing the EVSE to de-energize the cable conductors. The tether however, is problematic because it may be expensive to manufacture, may trip the de-energizing feature before the cord is stretched to an excessive length, may cause confusion if the magnet is removed from the EVSE and the operator is unaware that it needs to be put back in the proper position for the charging station to work, etc.

### Pilot Conductor Disconnect

Some of the inventive principles of this patent disclosure relate to de-energizing an EVSE charging cord by disconnecting a pilot conductor before the power conductors when the cord disengages from the EVSE due to excessive strain.

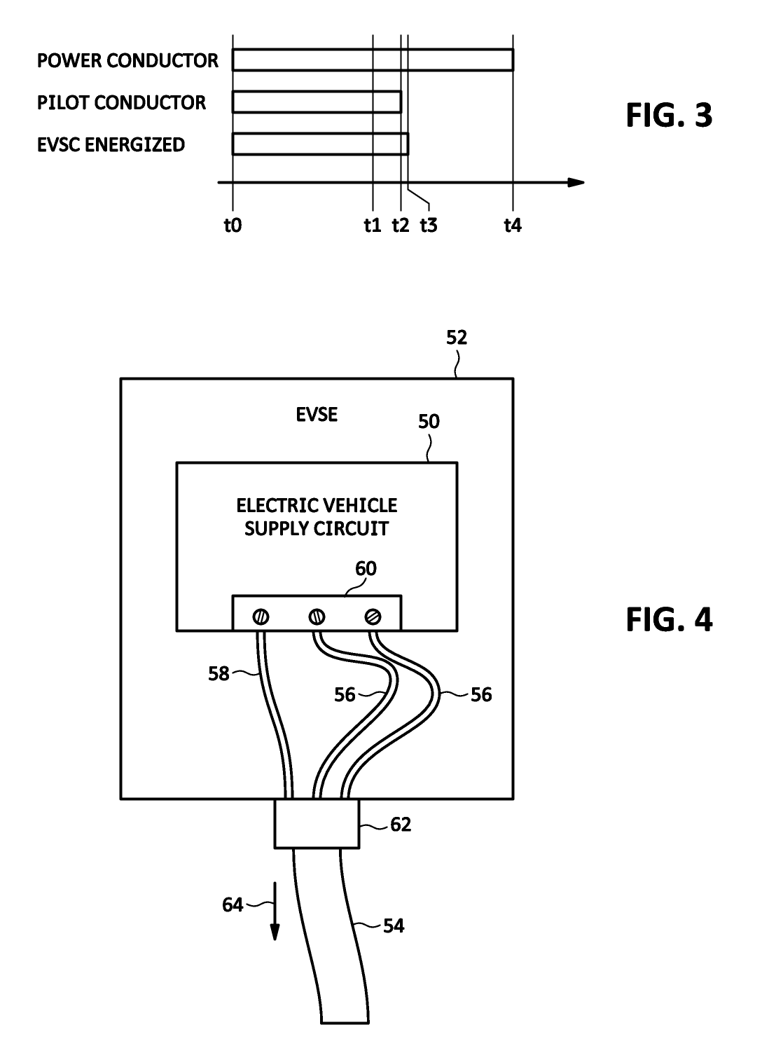

FIG. 3 illustrates an embodiment of a technique for de-energizing an EVSE charging cord according to some inventive principles of this patent disclosure. The technique illustrated in FIG. 3 is described in the context of an EVSE system having a cord to connect the EVSE to an electric vehicle. The cord is attached to the EVSE in a manner that enables the cord to disengage from the EVSE when the cord is subjected to excessive strain. The cord includes at least one power conductor and a pilot conductor.

Referring to FIG. 3, the middle trace labeled PILOT CONDUCTOR indicates the state of the pilot conductor, i.e., whether the pilot conductor is connected to an electric vehicle supply circuit within an EVSE enclosure. The top trace labeled POWER CONDUCTOR indicates the state of one or more power conductors, i.e., whether the power conductors are connected to the electric vehicle supply circuit. The bottom trace labeled EVSC ENERGIZED indicates whether the electric vehicle supply circuit is attempting to energize the power conductors.

Beginning at time t0 on the left side of FIG. 3, the pilot and power conductors are all connected to the electric vehicle supply circuit, which is energizing the power conductors to supply charging power to an electric vehicle. At time t1, the charging cord begins being subjected to an excessive strain which begins to pull the cord away from the EVSE enclosure that houses the electric vehicle supply circuit. At time t2, the pilot conductor disconnects from the electric vehicle supply circuit thereby causing the supply circuit to lose the pilot control signal. When the electric vehicle supply circuit loses the pilot control signal, it automatically de-energizes the one or more power conductors at time t3, which may be essentially instantaneous with time t2. Finally, at time t4, the power conductors disconnect from the electric vehicle supply circuit as the cord becomes completely disengaged from the EVSE enclosure.

FIG. 4 illustrates an embodiment of an EVSE system having a breakaway charging cord according to some inventive principles of this patent disclosure. The embodiment of FIG. 4 includes an electric vehicle supply circuit 50 disposed within an EVSE enclosure 52. A charging cord 54 connects the electric vehicle supply circuit to an electric vehicle. The cord includes one or more power conductors 56 and a pilot conductor 58. The conductors are electrically and mechanically connected to the electric vehicle supply circuit through a screw-type terminal strip 60. A strain relief 62 engages the cord with the enclosure and is adapted to disengage the cord from the enclosure when the cord is subjected to excessive strain.

The pilot conductor 58 is arranged to disconnect from the electric vehicle supply circuit before the power conductors 56 when the cord disengages from the enclosure. In the embodiment of FIG. 4, this is accomplished by making the pilot conductor shorter than the power conductors. Thus, the power conductors have more slack than the pilot conductor, so when excessive force is applied to the cord and the strain relief begins to fail, the cord is pulled away from the enclosure in the direction shown by arrow 64, and the pilot conductor pulls out of the terminal strip before the slack is taken up in the power conductors. When the pilot conductor pulls out of the terminal strip, the electric vehicle supply circuit loses the pilot signal which causes it to automatically de-energize the power conductors. Therefore, the power conductors are de-energized before the cord is pulled enough to result in either cable rupture or separation of the cable from the EVSE housing or charge coupler, and the exposure of live parts.

The inventive principles are not limited to the specific implementation details illustrated in the embodiment of FIG. 4. For example, there are countless alternate ways in which the pilot conductor can be made to disconnect from the electric vehicle supply circuit before the power conductors. In some embodiments, rather than terminating the pilot conductor in a terminal strip, a wire nut may be used to join the pilot conductor to a wire lead soldered to a circuit board on which some or all of the electric vehicle supply circuit resides. As long as the combined length of the pilot conductor and wire lead has less slack than the power conductors, the pilot conductor will disconnect from the wire lead at the wire nut before the power conductors separate from the terminal block or other termination device. In other embodiments, the wire nut may be replaced with a calibrated breakaway connector. In still other embodiments, the wire nut may be replaced with a sliding contact connector such as the Powerpole connector from Anderson Power Products to provide a highly predictable separation action.

As another example, the pilot and power conductors do not have to terminate at or near the same location. As long as the pilot conductor and wire lead has less slack than the power conductors, the pilot conductor will disconnect from the electric vehicle supply circuit before the power conductors as the cord is pulled away from the enclosure.

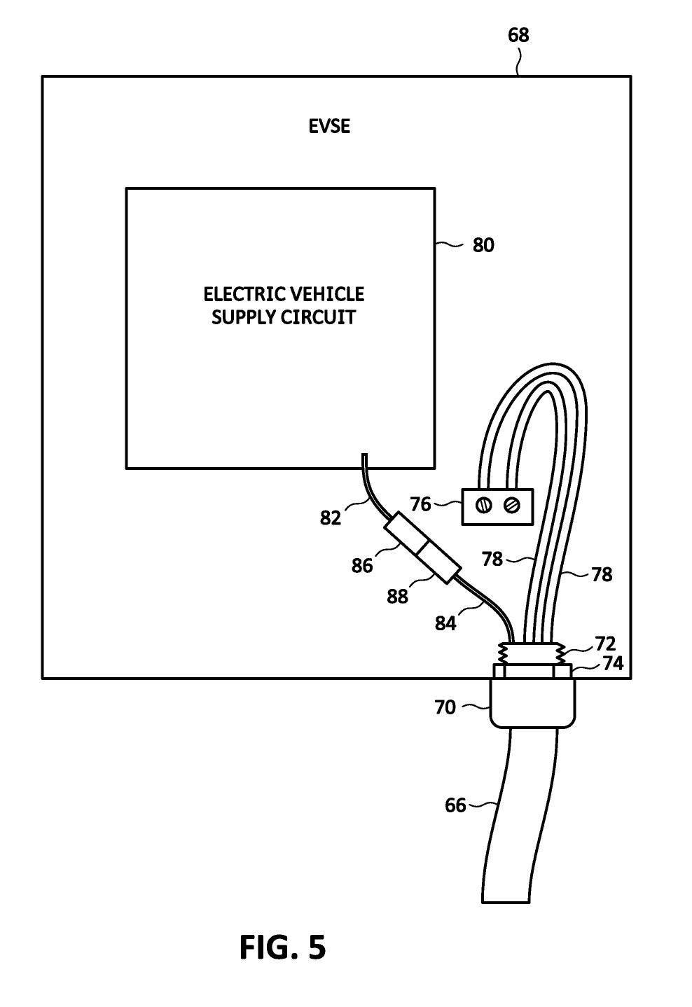

FIG. 5 illustrates another embodiment of an EVSE system having a breakaway charging cord according to some inventive principles of this patent disclosure. In the embodiment of FIG. 5, the charging cord 66 is attached to the EVSE enclosure 68 with a strain relief 70 having a cylindrical threaded body 72 that passes through a circular opening in a side wall of the enclosure 68. A nut 74 is threaded onto the cylindrical body to hold the strain relief in place on the enclosure. The electric vehicle supply circuit includes a relay module 76 on which the power conductors 78 of the charging cord terminate. The relay module is controlled by electronics on a circuit board 80. A wire lead 82 is soldered into the circuit board and connected to the pilot conductor 84 of the cord through a sliding contact connector having mating halves 86 and 88.

The power conductors 78, which may terminate on the relay module with screw terminals, spade lugs, or any other suitable termination device, are arranged with looping slack portions as shown in FIG. 5. The combined pilot conductor 84 and wire lead 82, however, is relatively tight with little slack. When excessive force is applied to the cord, the strain relief begins to pull out of the hole in the enclosure, and the connector halves 86 and 88 are pulled apart as the pilot conductor is pulled with the cord.

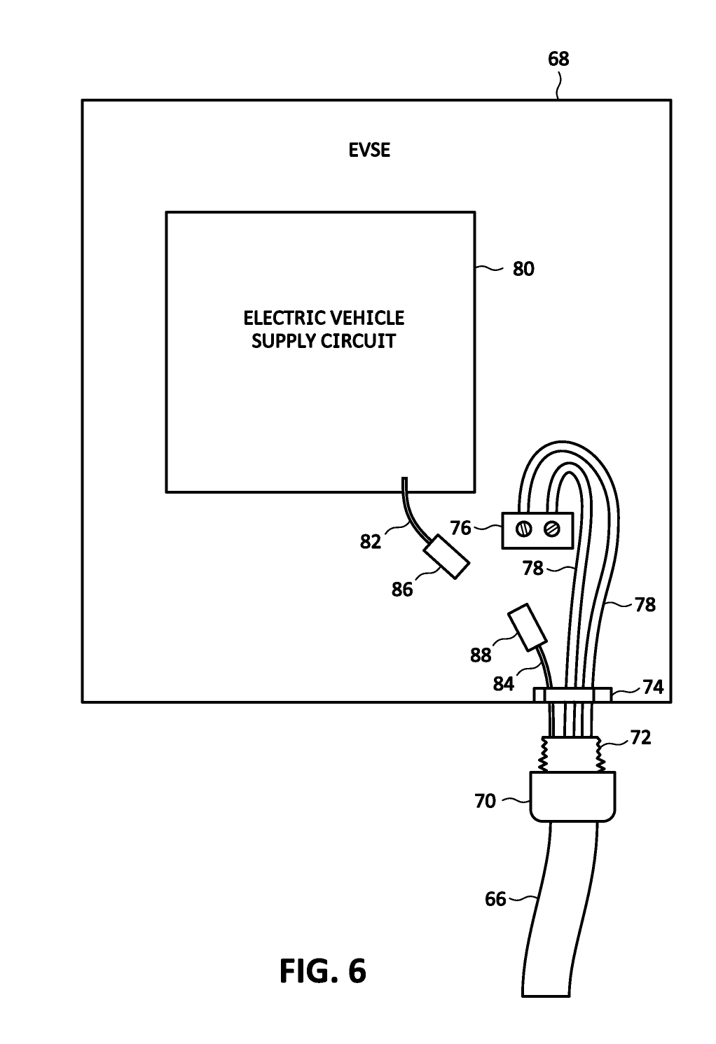

FIG. 6 illustrates the embodiment of FIG. 5 when the cord 66 has been pulled far enough to cause the strain relief 70 to disengage from the enclosure 68, but not far enough to disconnect the power conductors from the relay module 76. The connector halves 86 and 88 between the pilot conductor 84 and wire lead 82 have disconnected, thereby causing the electric vehicle supply circuit loses the pilot signal and automatically de-energize the power conductors by switching off relay module 76. The threads on the top portion of the body 72 are stripped as the nut 74 slides off the strain relief. As the cord continues to be pulled, the power conductors may become exposed and/or disconnected from the relay module, but by that time they have been de-energized.

A potential benefit of the embodiment of FIGS. 5 and 6 is that the circular shape of the strain relief may enable the strain relief to provide suitable breakaway action regardless of the direction in which the cord is pulled. That is, it may break away from the enclosure if the cord is pulled in a direction parallel to the enclosure wall throughout an entire 360 degree range. It may also break away if tugged in a direction perpendicular to the wall, or at any combined diagonal angle. The strain relief may also provide a relatively low cost solution because a mass-produced strain relief may be utilized. Moreover, the threaded body and nut may implement an accurately calibrated pull-out force. For example, if the threaded body is fabricated from plastic, it may provide a relatively low pull-out force which may be required in some applications, whereas an aluminum or steel body may provide a relatively high pull-out force for other applications where greater resistance to breakaway may be useful.

### EVSE Enclosure with Breakaway Portion

Some additional inventive principles of this patent disclosure relate to EVSE enclosures having breakaway portions through which the charging cord is attached.

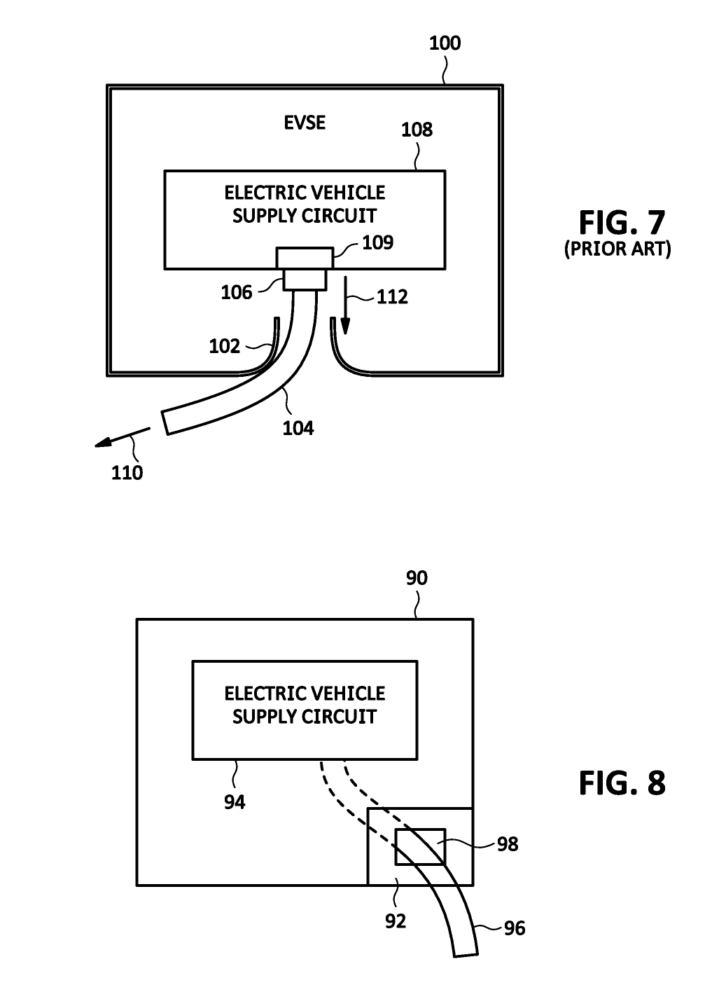

One prior art technique for accommodating the mechanical forces encountered when an EVSE cord is subjected to excessive strain is illustrated in FIG. 7. An EVSE enclosure 100 is provided with a cone-shaped entrance 102. The cord 104 is connected to the electric vehicle supply circuit 108 through a connector 109 in the enclosure with a plug 106 which requires a calibrated pull-out force to disengage from the connector 109. The cone-shaped entrance translates a force in the direction shown by arrow 110 on cord 104 into a vertical force as shown by arrow 112 so that the same amount of force is required to disengage the plug from the connector, regardless of the angle at which the cord is pulled. The arrangement illustrated in FIG. 7, however, is expensive to manufacture and takes up valuable space in the enclosure.

Another prior art technique involves the use of a strain relief having a square plastic flange that is attached to a sheet metal enclosure with screws located at each of the four corners of the flange. The cord and strain relief break away from the enclosure as the plastic flange fails when it reaches the disengagement force. The disengagement force, however, depends on the angle at which the cord is pulled because the square footprint of the flange provides a different holding force depending on whether the cord is pulled in a straight or diagonal direction with respect to the square.

FIG. 8 illustrates an embodiment of an EVSE system having an enclosure with a breakaway portion according to some inventive principles of this patent disclosure. The embodiment of FIG. 8 includes an enclosure 90 having a breakaway portion 92. An electric vehicle supply circuit 94 is disposed within the enclosure. A charging cord 96 connects the electric vehicle supply circuit to an electric vehicle through an opening 98 in the breakaway portion of the enclosure. The breakaway portion of the enclosure is adapted to disengage from the enclosure when the cord is subjected to excessive strain.

The inventive principles illustrated in FIG. 8 may be implemented in countless ways. For example, any suitable material may be used for the enclosure including metal, plastic, composites, etc. The breakaway portion of the enclosure may be integral with the enclosure or it may be a separate piece. An example of integral construction is a molded plastic enclosure in which the portion surrounding the cord opening is molded to a smaller thickness than the remainder of the enclosure to purposely create a weaker portion that can break away from the remainder of the enclosure when subjected to excessive strain. The opening may completely surround the entire cord, or it may surround only a portion, as for example, a U-shaped opening which may enable the cord to be assembled to the breakaway portion without having to thread the cord through the opening. The breakaway portion of the enclosure may be implemented in any suitable shape, although a substantially circular shape may provide uniform breakaway force regardless of the direction in which the cord is pulled.

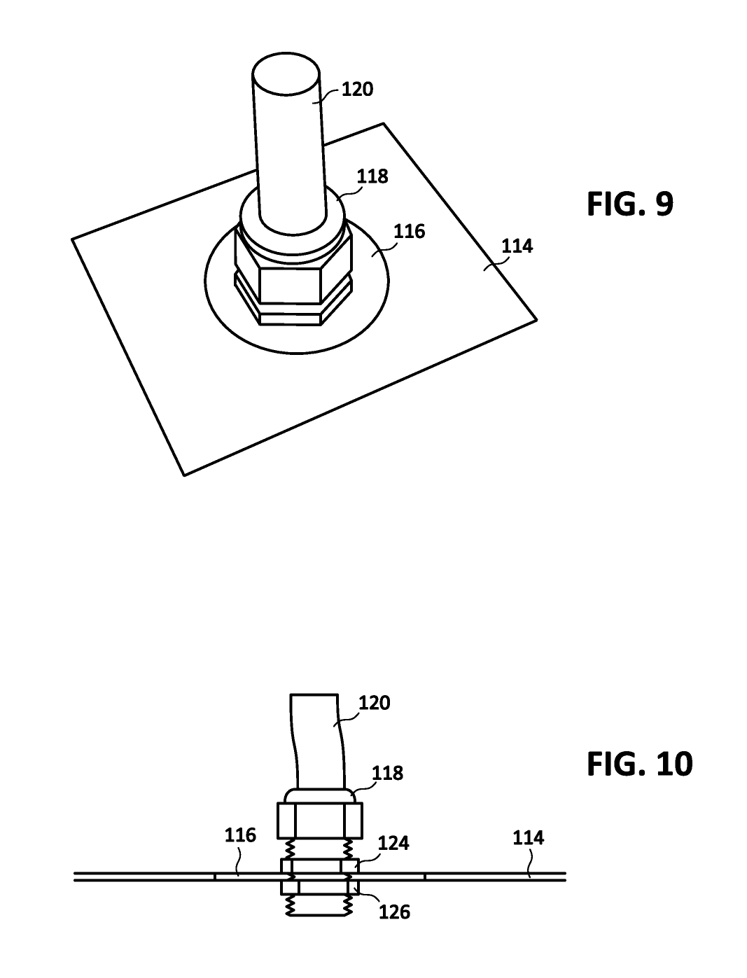

FIG. 9 is a perspective view of another embodiment of an EVSE system having an enclosure with a breakaway portion according to some inventive principles of this patent disclosure. In the embodiment of FIG. 9, a sheet metal portion of enclosure 114 includes a circular disk 116 that is adapted to fit into a corresponding opening in the enclosure in such a manner as to break free from the enclosure with a pre-calculated force. For example, the disk may be sized for an interference fit with the opening to produce a large disengagement force. The disk may be sized for a slip fit or loose fit with the opening to produce a light disengagement force, although a slip or loose fit may also require the use of other mechanisms to retain the disk in the opening. For example, one or more nicks or staking may be used to retain the disk until the precalculated force is applied. Other techniques for retaining the disk include the use of adhesives, paint, powder coatings, etc. The amount and type of material used to retain the disk may be adjusted to provide a precisely controlled disengagement force. The amount and type of material may also be adjusted to protect the enclosure and/or its contents from environmental effects. For example, paint or powder coatings having adequate water resistance and film strength may be selected to provide a water-tight seal for embodiments intended for installation in damp or wet locations.

In the embodiment of FIG. 9, the disk includes a circular opening sized to accept a conventional strain relief 118 that secures charging cord 120 to the enclosure. The strain relief may be fabricated from plastic, metal, or any other suitable material. It may be a separate component as shown in FIG. 9, or all or part of the strain relief may be formed integrally with the disk.

FIG. 10 is a cut-away view of the embodiment of FIG. 9. The strain relief 118 includes a threaded body 122 having two lock nuts 124 and 126 to secure the strain relief to the disk 116. In this example, the disk is shown having a slip fit with the enclosure 114 and thus paint, powder coating, etc., may be used to secure the disk to the enclosure.

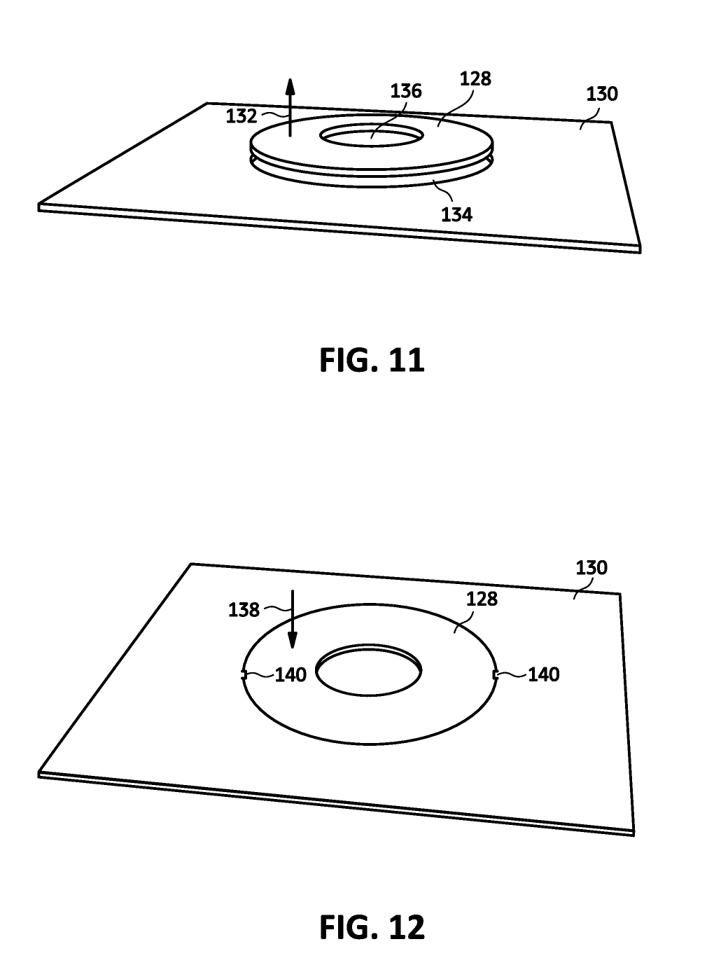

FIGS. 11 and 12 illustrate an embodiment of a method for forming a breakaway portion of an enclosure according to some inventive principles of this patent disclosure. Referring to FIG. 11, a disk 128 is punched out to form a sheet metal enclosure 130 in the direction of arrow 132, thereby leaving an opening 134. A mounting hole 136 for a strain relief may be formed in the disk during the same or a separate punching process. Referring to FIG. 12, the disk is subsequently pressed back into the opening in the direction of arrow 138 so that the disk is reseated with the flat surface of the disk being flush with the surface of the enclosure. In this example, one or more nicks 140 are formed in the enclosure and/or disk to provide additional holding force. The enclosure with the disk in place is then powder coated or painted. The coating provides protection against corrosion, but may also be adjusted in terms of film strength, hardness, etc., to provide additional holding force before the disengagement force is reached. In other embodiments, the disk may only be pressed partially back into the opening 134 to change the amount of holding force.

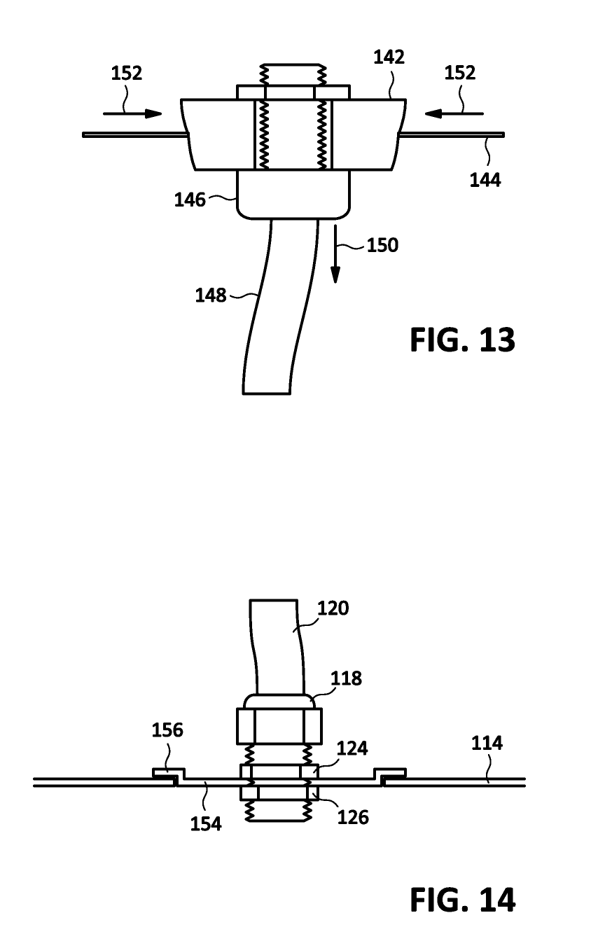

FIG. 13 is a cutaway view illustrating another embodiment of an EVSE system having an enclosure with a breakaway portion according to some inventive principles of this patent disclosure. In the embodiment of FIG. 13, a tapered stopper 142 is used as the breakaway portion of the enclosure. The stopper 142 may be formed from rubber or other pliable material and is press fit into a suitably sized and shaped opening in the enclosure 144. A conventional strain relief 146 is mounted in a hole through the stopper to retain charging cord 148 in place.

In the embodiment of FIG. 13, the stopper is assembled with the wide end on the inside of the enclosure. This configuration causes the holding force to gradually increase as the cord 148 is pulled from the enclosure in the direction of arrow 150 because the opening in the enclosure increasingly compresses the stopper in the direction of arrows 152 due to the taper of the stopper. Once the wide end of the stopper passes through the opening, however, the entire assembly of the cord, strain relief and stopper break away from the enclosure. In other embodiments, however, the stopper may be assembled into the enclosure with the wide end on the outside of the enclosure to provide a gradually decreasing holding force as the cord is pulled from the enclosure.

The size, shape, hardness and other characteristics of the stopper may be adjusted to provide any suitable disengagement force, pattern, etc. Although the inventive principles are not limited to circular stoppers, the use of a circular stopper may provide a uniform disengagement force regardless of the direction in which the cord is pulled.

FIG. 14 is a cutaway view of another embodiment of an EVSE system having an enclosure with a breakaway portion according to some inventive principles of this patent disclosure. The embodiment of FIG. 14 is similar to that of FIGS. 9 and 10, but the breakaway portion 154 is formed as a plug having a lip 156 to engage the surface of the enclosure 114. This may enable easier assembly because the lip causes the plug to stop moving once it is fully engaged with the enclosure. Moreover, the lip may provide an interface for applying an adhesive or other type of material between the plug and enclosure. The width, thickness, adhesion, etc. of the material may be adjusted to provide a calibrated and uniform holding force.

The inventive principles of this patent disclosure have been described above with reference to some specific example embodiments, but these embodiments can be modified in arrangement and detail without departing from the inventive concepts. Thus, any changes and modifications are considered to fall within the scope of the following claims.

1. An electric vehicle charging system comprising:
an enclosure;
an electric vehicle supply circuit disposed within the enclosure;
a cord to connect the electric vehicle supply circuit to an electric vehicle, wherein the cord includes a power conductor and a pilot conductor; and
a strain relief to engage the cord with the enclosure, wherein the strain relief is adapted to disengage the cord from the enclosure when the cord is subjected to excessive strain;
wherein the pilot conductor is arranged to disconnect from the electric vehicle supply circuit before the power conductor when the cord disengages from the enclosure.

2. The system of claim 1 wherein the portion of the pilot conductor between the strain relief and the electric vehicle supply circuit has substantially less slack than the portion of the power conductor between the strain relief and the electric vehicle supply circuit.

3. The system of claim 2 wherein the pilot conductor includes a disconnect device.

4. The system of claim 3 wherein the disconnect device comprises a wire nut.

5. The system of claim 3 wherein the disconnect device comprises a breakaway connector.

6. The system of claim 3 wherein the disconnect device comprises a sliding contact connector.

7. The system of claim 1 wherein the strain relief comprises a substantially cylindrical body arranged in a hole in the enclosure.

8. The system of claim 7 wherein the cylindrical body is threaded and the strain relief further comprises a nut engaged with the threaded body.

9. An electric vehicle charging system comprising:
an enclosure having a breakaway portion;
an electric vehicle supply circuit disposed within the enclosure;
a cord to connect the electric vehicle supply circuit to an electric vehicle; and
a strain relief to engage the cord with the breakaway portion of the enclosure;
wherein the breakaway portion of the enclosure is adapted to disengage from the enclosure when the cord is subjected to excessive strain.

10. The system of claim 9 wherein the breakaway portion comprises a punch-out.

11. The system of claim 10 wherein the punch-out is secured to the enclosure with a coating.

12. The system of claim 10 wherein the punch-out is secured to the enclosure with a nick.

13. The system of claim 10 wherein the punch-out is secured to the enclosure with friction.

14. The system of claim 9 wherein the breakaway portion is substantially circular.

15. The system of claim 9 wherein the breakaway portion comprises a plug.

16. The system of claim 15 wherein the plug comprises a tapered stopper.

17. The system of claim 15 wherein the plug comprises a lip to engage the enclosure.

18. An assembly comprising:
an enclosure having a breakaway portion; and
an electric vehicle supply circuit disposed within the enclosure;
wherein the breakaway portion includes an opening for a cord to connect the electric vehicle supply circuit to an electric vehicle; and
wherein the breakaway portion is adapted to disengage from the enclosure when the cord is subjected to excessive strain.

19. The assembly of claim 18 wherein the breakaway portion comprises a punch-out.

20. The assembly of claim 18 wherein the breakaway portion comprises a plug.
